(19) United States
(12) Patent Application Publication
(10) Pub. No.: US 2019/0228444 A1
(43) Pub. Date: Jul. 25, 2019

(54) SYSTEMS AND METHODS FOR REAL TIME ALLOCATION OF ECONOMIC CONTRIBUTIONS OF THIRD PARTIES TO A PRODUCT

(71) Applicant: PAAT, INC., Brentwood, TN (US)

(72) Inventors: James Kirby Best, Brentwood, TN (US); David John Pullin, Wake Forest, NC (US)

(73) Assignee: PAAT, INC., Brentwood, TN (US)

(21) Appl. No.: 16/255,473

(22) Filed: Jan. 23, 2019

Related U.S. Application Data
(60) Provisional application No. 62/621,249, filed on Jan. 24, 2018.
(60) Provisional application No. 62/620,671, filed on Jan. 23, 2018.

(51) Int. Cl. G06Q 30/02; G06Q 30/06; G06Q 20/12

(52) U.S. Cl. CPC G06Q 30/0283; G06Q 50/04; G06Q 20/12; G06Q 30/0621

(57) ABSTRACT

A system for real time allocation of economic contributions of third parties to a product, the system comprising memory and a processor. The memory includes executable instructions that upon execution by the processor cause the system to: display to a user an image of the predetermined product, the predetermined product having various states based on variable data; receive input data from the user regarding the various states; communicate, in real time, the input data to one or more servers configured to generate at least one simulated product based on the input data; receive, in real time, the simulated product from providers; display, in real time, to the user the simulated product; receive ordering input from the user based on the simulated product; allocate, based on the ordering input of the at least one simulated product, an economic value associated with the ordered simulated product.

### CROSS-REFERENCE TO RELATED APPLICATIONS

This application is a non-provisional application and cites the priority of U.S. App. No. 62/621,249, filed 24 Jan. 2018, which is currently pending, and U.S. App. No. 62/620,671, filed 23 Jan. 2018, which is currently pending. U.S. App. Nos. 62/621,249 and 62/620,671 are incorporated herein by reference in their entireties.

### BACKGROUND

The present invention relates generally to systems and methods for determining real time economic contributions of third parties to a product having variable states.

Various systems are known in the art that allow users to select a predetermined product (e.g., a shirt or automobile) and select variable data for that product (e.g., color or size). For example, a user visits the website of a clothing retailer, selects a shirt, and is given choices of color and size. However, these systems fail to provide the user with further choices other than those directly offered by the retailer, and are limited to predetermined options offered by the retailer.

What is needed then, are systems and methods for offering further product states other than those provided by a retailer or those who typically sell goods. These preferred systems and methods should facilitate communicating variable product states from multiple parties and display the variable product states to the user in an integrated and seamless way. The preferred systems and methods should allow for a user to select and purchase a product having variable data from multiple parties, wherein each party contributed to the selected product, and automatically and in real time allocate an economic value of the variable data from each party to the selected product. These needed systems and methods are lacking in the art.

### BRIEF SUMMARY OF THE INVENTION

Included herein is a system for real time allocation of economic contributions of third parties to a product, the system comprising memory and a processor, the memory including executable instructions that upon execution by the processor cause the system to perform actions. The execution of the instructions cause the system to store variable data regarding a predetermined product. The predetermined product may be an article of clothing, such as a dress, a shirt, pants, a jacket, a blouse, or any other type of product. The variable data may include sizing data, color data, garment information (e.g., collar type or fastener type), or a combination thereof. The execution of the instructions cause the system to display to a user an image of the predetermined product, the predetermined product having various states based on the variable data.

The execution of the instructions cause the system to receive input data from the user regarding the various states. The execution of the instructions cause the system to communicate, in real time, the input data to one or more servers configured to generate at least one simulated product based on the input data. The execution of the instructions cause the system to receive, in real time, the at least one simulated product from the one or more servers. The execution of the instructions cause the system to display, in real time, to the user the at least one simulated product. The execution of the instructions cause the system to receive ordering input for the at least one simulated product from the user. The execution of the instructions cause the system to allocate, based on the ordering input of the at least one simulated product, an economic value associated with the at least one simulated product received from the one or more servers.

In an embodiment, the memory of the system may include executable instructions that upon execution by the processor cause the system to receive payment information for the at least one simulated product. The executable instructions may, upon execution by the processor, cause the system to automatically transmit payment information, based on the allocated economic value.

In some embodiments, the one or more servers comprises two or more servers, wherein each of the two or more servers is configured to generate at least one simulated product based on the input data.

In an embodiment, the executable instructions may, upon execution by the processor, cause the system to calculate pricing information for the at least one simulated product based on the communicated input data, and display the pricing information to the user. The executable instructions, upon execution by the processor, may cause the system receive altering data from the user to modify the at least one simulated product, transmit, in real time, the altering data to the one or more servers, and receive, based on the altering data, the modified at least one simulated product.

In an aspect, a system for real time allocation of economic contributions of third parties to a product is provided, the system comprising memory and a processor, the memory including executable instructions that upon execution by the processor cause the system to perform steps. These instructions cause the system to store variables associated with at least one variable feature of a predetermined product; display to a user an image of the predetermined product, the predetermined product having various states based on the at least one variable feature; receive input data from the user regarding the at least one variable feature; communicate, in real time, the input data to one or more servers configured to generate at least one simulated variable product feature; receive, in real time, the at least one simulated variable product feature from the one or more servers; generate one or more simulated products based on the at least one simulated variable product feature and the predetermined product; transmit, in real time, the one or more simulated products to the user; receive ordering input from the user for the one or more simulated products; allocate, based on the ordering input of the at least one simulated product, an economic value associated with the at least one simulated variable product feature received from the one or more servers.

In an embodiment, the executable instructions, upon execution by the processor, may cause the system to automatically transmit payment information based on the allocated economic value.

In a further aspect, a system for real time allocation of economic contributions of third parties to a product is provided. The system comprises memory and a processor, and the memory includes executable instructions. Upon execution by the processor, the executable instructions cause the system to store variables associated with at least one variable feature of a predetermined product; generate one or more simulated products based on the at least one variable product feature; display to a user the one or more simulated products; receive ordering information from the user relating to the one or more simulated products; and allocate, based on at least one variable feature of the simulated products, economic value associated with the at least one variable feature.

It is therefore a general object of the current disclosure to, in real time, provide a system for enabling purchasers of a product to select variable features of the product from one or more third party providers and purchase the selected product.

Another object of the current disclosure is to determine, in real time, economic allocation of value of the variable features from the one or more third party providers.

Yet another object of the present disclosure is to receive payment information from the purchaser, and automatically transmit payment information to the one or more third parties based on the determined economic allocation.

Other and further objects, features and advantages of the present disclosure will be readily apparent to those skilled in the art upon reading of the following disclosure.

### BRIEF DESCRIPTION OF THE DRAWINGS

FIG. 1 illustrates an embodiment of a system for real time allocation of economic contributions of third parties to a product.

FIG. 2 illustrates layers and identification tags of providers according to an embodiment of the system.

FIG. 3 illustrates another embodiment of a system for real time allocation of economic contributions of third parties to a product.

### DETAILED DESCRIPTION

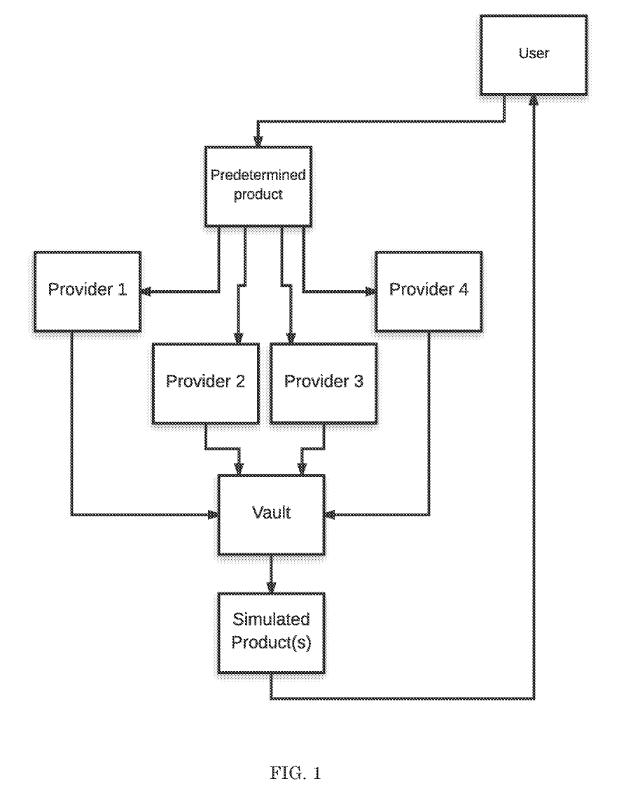

Referring to FIGS. 1-3, a system for real time allocation of economic contributions of third parties to a product is provided. The system includes memory configured to store computer executable instructions and a processor configured to execute the computer executable instructions. Upon execution of the computer executable instructions by the process, the system is configured to perform a variety of actions. The execution of instructions may cause the system to store variable data regarding a predetermined product. It is noted that while the lines of the accompanying drawings denote communication/processes, the direction of the arrows (i.e., communication and processes) may be reversed, two-way, or one-way. While the current disclosure uses “product,” it will be appreciated that the presently disclosed systems and methods may apply to services, such as manufacturing processes, computer programming, investment methods, architectural plans, and legal documents. Thus, the term “service” may used in place of “product” when consistent with the context used. As used herein, “user” may refer to customer and vice-versa.

Examples of predetermined products are articles of clothing, accessories, automobiles, appliances, and household goods such as furniture and flatware, structures such as houses, planes, and helicopters. In an embodiment, the predetermined product is a dress, a shirt, pants, a jacket, a blouse, a handbag, or luggage. As used herein, a predetermined product means a base product that has a variety of variable data, resulting in corresponding product states. Variable data may include, for example, color, fit, finish, size, design, ornamentation, fastener type, style, etc. By way of example, if the predetermined product is a shirt, the shirt may have variable data associated therewith, such as fastener type (buttons, zipper, no fastener etc.), size, collar type, cut (neckline, shoulder, sleeves, etc.) color, length, surface pattern, fabric, and ornamentation. The execution of the instructions may cause the system to display to a user an image, or representation, of the predetermined product, the predetermined product having various states based on the variable data.

The execution of the instructions cause the system to receive input data from the user regarding the various states. Thus, the user can enter input data, such as through a keyboard or a graphical user interface (GUI), to view various states of the predetermined product, based on an almost limitless selection of variable data. The system may generate a virtual and/or augmented reality of the product, which may include a simulation of the user wearing/using the product. The system may be configured to receive the input data based on the user's preferences. Thus, if the predetermined product is a shirt, the user may select one button style, a certain type of cut, a fabric design, and a color. The system may communicate, in real time, input data to one or more servers configured to generate at least one simulated product based on the input data to display the simulated product in the state selected by the user.

The one or more servers may be configured to communicate with, located at, or controlled by, one or more providers. As used herein, a “provider” is a provider that provides, or generates, one or more predetermined products, simulated products, or variable data of a simulated product to the system. Thus, providers can design, store, and generate new features (i.e., variable data) for products, and the system allows for the providers to easily interface and display their new features to users shopping for a product. By way of example, a first provider may provide and communicate one or more surface patterns of a shirt, while a second provider may communicate additional surface patterns of a shirt and various fastener designs, such as the shirt with buttons or a zipper. The system may receive the simulated products from the one or more servers on the one or more providers, respectively, and display the respective simulated products to the user. By way of example, the system may be configured to communicate with two or more servers, each of the two or more servers located at or controlled by a respective provider, and each of the two or more servers configured to generate at least one simulated product, or a variable data of the simulated product, and transmit the simulated product or variable data to the system. The system is configured to receive the simulated product or variable data and cause the simulated product, or a simulated product based on the variable data, to be displayed to the user. The user, the one or more servers, and/or the providers may communicate over one or more networks, such as the Internet.

The user may select the one or more product states, or variable data, of each of the simulated products. Advantageously, the user may select one feature from one provider (e.g., the surface pattern of the first provider) and another feature from another provider (e.g., the buttons or zipper from the second provider). Thus, the system enables the user to choose simulated products combining aspects from various providers in real time. The system may be configured to receive ordering input from the user regarding which simulated product with the various states that the user would like to order.

The system may receive ordering input regarding the selections of the various states of the simulated product. The system may communicate the ordering input to one of the one or more providers such that the one or more providers can create a product to ship to the user based on the ordering input.

The execution of the instructions may cause the system to receive input instructions in the form of a command, or request, from the user. The command may be, for example, instructions from the user regarding the predetermined product. For example, while input data may be color and cut of a dress, a command may be “a slimming dress.” The system may transmit the command to one or more providers configured to generate at least one simulated product based on the command. In the preceding example, the one or more providers may each generate one or more simulated slimming dresses having product states that make the dress a slimming dress, such as a pleated waistband, a fabric twist at the bust, slimming seaming, color blocking, vertical folds, or dark fabric color. As described herein, the system, particularly the vault, may combine, or the providers may combine, the various product states based on the other providers input data to form one or more simulated products, such as the one or more simulated slimming dresses. The user then can select and/or order the one or more simulated slimming dresses that the user desires to purchase.

The system may be configured to generate manufacturing instructions, such as fabrics and sewing patterns, regarding the simulated product that a user selects and/or orders. The manufacturing instructions may be computer executable instructions that can executed by, for example, computers that control manufacturing processes, such as commercial sewing machines. The manufacturing instructions may be transmitted to the one or more providers.

An exemplary embodiment of the system is shown in FIG. 1. Computer executable instructions containing a predetermined product may be stored on a server of the system. The server communicates with one or more providers the predetermined product, and providers add or change various states of the product. The providers communicate with a “vault,” which may be contained on the server of the system or another, second server. As used herein, “vault” is referred to one or more computers, such as a server, that contain executable instructions configured to differentially communicate with different aspects of the system, such as the servers/clients of providers, retailers, and manufacturers, and securely store information, such as manufacturing instructions.

The providers may include in their addition or changes, or as part of the communication, the economic value associated with their addition or changes of the product state. The vault may assign a unique identification tag, as described below, to the product state communicated by each provider. The unique identification tag may be secure such that it may not be unsecurely altered by parties other than by that corresponding provider. The secure identification tag may include the economic value that the provider associates with its contribution. The identification tag is particularly advantageous in embodiments of the system where the simulated product is altered or added to by more than one provider, each provider adding or changing product state(s) based on what earlier providers had done. For example, if a predetermined product is a specific model of automobile having a base price of $25,000, and a first provider adds red triangular quilted leather seating with a specified economic value of $200, second provider adds a signature patterned headliner with an economic value of $1500, and a third provider adds a special edition golf club set to accompany the automobile with an economic value of $700, the vault would assign a unique and secure identification tag to each provider such that the later providers would be unable to remove the secure identification tag specifying the provider and economic value of that provider's contribution. In this example, if a customer ordered the automobile with the additions of the three providers, the system would calculate the total price to collect from the customer, or retailer, and then automatically allocate payments that correspond to the providers' unique identification tags, including their respective specified economic values.

In one embodiment of the system, the one or more providers add or alter respective product states in layers to the predetermined product. For example, if the predetermined product is a sofa, a first provider may add a fabric design, such as a subtle herringbone fabric design, while a second provider adds brass nail head trim, and a third provider adds a chesterfield sofa shape. To the user, the simulated product appears seamless, as the user may not be able to determine the product is the result of input from one or more providers. The providers may provide layers without any human involvement in the decision-making such that complex algorithms (e.g., artificial intelligence) in determining the product state of each respective layer.

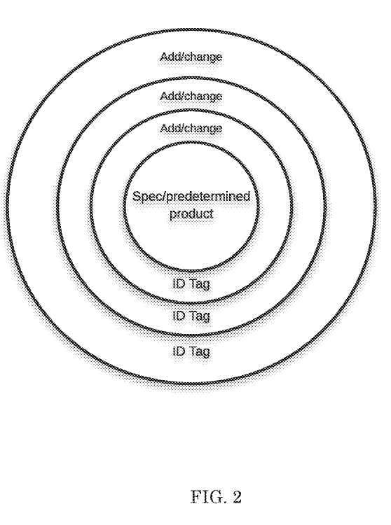

As shown in FIG. 2, an embodiment of the system may assign layers with the unique identification tag to the contributions (i.e., specification) of each of the one or more providers. The unique identification tag, for example, serves to identify the provider that generated the layer as each layer is added. To continue the prophetic sofa example, each of the first, second, and third layers provided by the respective first, second, and third providers may possess a unique identification tag. If a fourth provider receives the predetermined product with these three layers and adds a fourth layer for sofa bed functionality, the three layers would have the unique identification tags of the first, second, and third providers, and the fourth unique identification tag for the sofa bed functionality. The unique identification tags of the layers may be secure such that providers cannot change or remove the unique identification tags belonging to other layers. The system may generate and add its own layers, such as manufacturing instruction layers that are secure and not visible to third parties other than the manufacturer.

The system may determine and allocate, in real time, an economic value associated with the at least one simulated product received from the one or more servers of the provider(s). The predetermined product may have a base value, with each aspect (i.e., layer) of the simulated product adding an associated value to the base value. Alternatively, providers of product states/aspects (i.e., layers) may determine the economic value added by their product states. The system may track these added values by including the economic value with the unique identification tag, or associating the economic value with the unique identification tag. The system may be configured to determine, in real time, the premium over the base value that a user will pay for the simulated product, based on the aspects that the user has selected. By way of example, if the user selects variable data of a simulated product of a dress having a stitching pattern by Provider A, a fabric surface ornamentation of Provider B, and a neckline of Provider C, the system may automatically determine and allocate the economic value of each of the variable data. The allocated economic value may be based on, for example, the relative demand of that particular feature (i.e., variable data) among users, and the cost of manufacturing a product incorporating the selected variable data. The system may be configured to receive payment information from the user, such as credit card or debit card purchase information. The system may be configured to automatically transmit payment information to the one or more providers based on the allocated economic value determined for the respective one or more providers of the simulated product selected by the user. The system may be configured to automatically transmit payment and/or payment information to the one or more providers based on the allocated economic value.

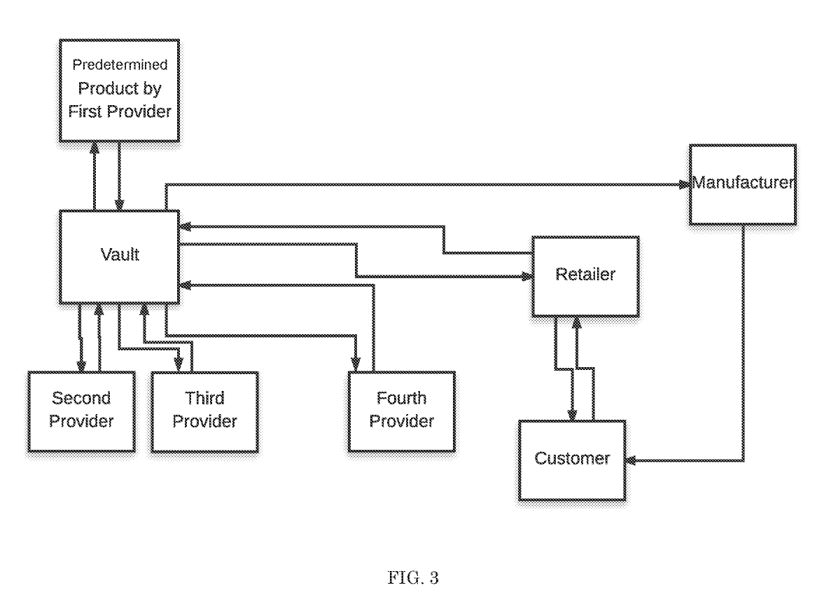

FIG. 3 illustrates an embodiment in accordance with the present disclosure. A predetermined product having various product states is provided by a first provider to the vault on a first server. The first provider may specify an economic value associated with the predetermined product. The vault may communicate the predetermined product to one or more providers, who each may make changes/or additions to one or more product states of the predetermined product. Each provider may communicate its changes/additions to the product states with the vault, along with the respective economic value associated with the changes/additions, and the vault may assign a unique identification tag to each the changes/additions of each provider. Each provider may include manufacturing instructions regarding how to manufacture its additions/changes, which the vault may secure and/or store and not communicate, when communicating with other providers and the retailer. The vault may communicate one or more simulated products, based on the predetermined product and changes/additions of the providers, to a retailer. The retailer may communicate the one or more simulated products to a customer, who may place an order for the one or more simulated products. In some embodiments, the system may receive input data from the customer to solicit additional product states from the providers. Once ordering and payment instructions are received from the customer regarding the one or more simulated products, the retailer communicates corresponding instructions to the vault. The vault may communicate payment information to reach provider in accordance with their allocated economic values. The vault may communicate the product states and the predetermined product, including manufacturing instructions from the providers or manufacturing instructions generated by the vault, to a manufacturer. The manufacturer may manufacture the product in accordance with the product states, predetermined product, and manufacturing instructions, and direct-ship the manufactured product to the customer (as shown) or ship the manufactured product to the retailer for shipment to the customer.

In some aspects of the system, the predetermined product is provided by a provider such that the provider provides a base layer upon which providers can build, as described above.

The system may be configured to receive altering data from the user to modify the at least one simulated product. Thus, when a user views the displayed one or more simulated products (i.e., the product states), the user can enter further information to cause one or more additional simulated products to be generated and displayed. By way of example, if a user prefers a particular neckline on a dress, the user may select, or “like” the neckline. This altering data may be received by the system and transmitted to the one or more providers such that the one or more servers generate additional modified simulated product(s) having that neckline, or variations of that neckline, and the one or more servers transmit this to the system to cause the additional modified simulated product(s) to be displayed to the user. Advantageously, this feature allows the user to interact with the system and preview simulated products before purchasing the product. Additionally, the system enables the user to design and preview, as a simulated product, a bespoke product prior to purchasing it.

In some embodiments of the system where the providers generate and transmit the one or more simulated variable product features to be received by the system, the system may generate one or more simulated products based on the at least one simulated variable product feature and the predetermined product. The system may be configured to display this generated simulated product to the user.

In an embodiment of the system, the system contains executable instructions that cause the system to store variables associated with at least one variable feature of the predetermined product. The system is configured to generate one or more simulated products based on the at least one variable product feature, and display the one or more simulated products to the user. The system may receive ordering information from the user regarding the one or more simulated products, and the system may allocate, based on the at least one variable feature of the simulated products, economic value associated with the at least one variable feature. The variable features may be generated and provided by providers in communication with the system via one or more networks, such as the Internet.

Once the user has selected the simulated product she wishes to purchase and inputs the selection into the system, the system may receive the payment information from the user. After payment for the selected simulated product is complete, the system may generate manufacturing instructions based on the simulated product (e.g., which incorporates elements from the predetermined product and the variable data selected) and transmit these manufacturing instructions to one or more manufacturers in real time such that the item may be manufactured and sent to the user. The system may be configured to receive shipment information from the user, and the shipment information may be sent to the manufacturer so that the manufactured product, based on the simulated product selected by the user, can be directly shipped to the user.

Thus, although there have been described particular embodiments of the present invention of new and useful Systems And Methods For Real Time Allocation Of Economic Contributions Of Third Parties To A Product, it is not intended that such references be construed as limitations upon the scope of this invention except as set forth in the following claims.

1. A system for real time allocation of economic contributions of third parties to a product, the system comprising memory and a processor, the memory including executable instructions that upon execution by the processor cause the system to:
store variable data regarding a predetermined product;
display to a user an image of the predetermined product, the predetermined product having various states based on the variable data;
receive input data from the user regarding the various states;
communicate, in real time, the input data to one or more servers configured to generate at least one simulated product based on the input data;
receive, in real time, the at least one simulated product from the one or more servers;
display, in real time, to the user the at least one simulated product;
receive ordering input from the user for the at least one simulated product; and
allocate, based on the ordering input of the at least one simulated product, an economic value associated with at least one simulated product received from the one or more servers.

2. The system of claim 1, wherein the memory includes executable instructions that upon execution by the processor cause the system to:
receive payment information from the user based on the at least one simulated product.

3. The system of claim 1, wherein the memory includes executable instructions that upon execution by the processor cause the system to:
automatically transmit payment information, based on the allocated economic value.

4. The system of claim 1, wherein the one or more servers comprises two or more servers, wherein each of the two or more servers is configured to generate at least one simulated product based on the input data.

5. The system of claim 1, wherein the memory includes executable instructions that upon execution by the processor cause the system to:
calculate pricing information for the at least one simulated product based on the communicated input data; and
display the pricing information to the user.

6. The system of claim 1, wherein the memory includes executable instructions that upon execution by the processor cause the system to:
receive altering data from the user to modify the at least one simulated product;
transmit, in real time, the altering data to the one or more servers; and
receive, based on the altering data, the modified at least one simulated product.

7. The system of claim 1, wherein the predetermined product is an article of clothing.

8. The system of claim 7, wherein the input data includes sizing data, color data, garment information, or a combination thereof.

9. The system of claim 8, wherein the garment information includes collar type or fastener type.

10. The system of claim 1, wherein the one or more servers configured to generate at least one simulated product based on the input data are located at or controlled by a provider.

11. The system of claim 10, wherein system is configured to communicate via the Internet with the one or more servers located at or controlled by the provider.

12. A system for real time allocation of economic contributions of third parties to a product, the system comprising memory and a processor, the memory including executable instructions that upon execution by the processor cause the system to:
store variable data associated with at least one variable feature of a predetermined product;
display to a user an image of the predetermined product, the predetermined product having various states based on the at least one variable feature;
receive input data from the user regarding the at least one variable feature;
communicate, in real time, the input data to one or more servers configured to generate at least one simulated variable product feature;
receive, in real time, the at least one simulated variable product feature from the one or more servers;
generate one or more simulated products based on the at least one simulated variable product feature and the predetermined product;
transmit, in real time, the one or more simulated products to the user;
receive ordering input from the user for the one or more simulated products; and
allocate, based on the ordering input of the at least one simulated product, an economic value associated with the at least one simulated variable product feature received from the one or more servers.

13. The system of claim 10, wherein the memory includes executable instructions that upon execution by the processor cause the system to:
receive payment information from the user for the one or more simulated products.

14. The system of claim 10, wherein the memory includes executable instructions that upon execution by the processor cause the system to:
automatically transmit payment information based on the allocated economic value.

15. The system of claim 14, wherein the one or more servers from which the simulated variable product feature is received is located at, or controlled by, one or more providers, and wherein the automatically transmitted payment information is to the one or more providers.

16. The system of claim 12, wherein the one or more servers comprises two or more servers, each configured to generate at least two simulated variable product features based on the input data.

17. The system of claim 12, wherein the memory includes executable instructions that upon execution by the processor cause the system to:
calculate pricing information for the at least one simulated product based on the communicated simulated variable product feature; and
display the pricing information to the user.

18. The system of claim 12, wherein the predetermined product is an article of clothing.

19. A system for real time allocation of economic contributions of third parties to a product, the system comprising memory and a processor, the memory including executable instructions that upon execution by the processor cause the system to:
store variables associated with at least one variable feature of a predetermined product;
generate one or more simulated products based on the at least one variable product feature;
display to a user the one or more simulated products;
receive ordering information from the user relating to the one or more simulated products; and
allocate, based on at least one variable feature of the simulated products, economic value associated with the at least one variable feature.

20. The system of claim 19, wherein the memory includes executable instructions that upon execution by the processor cause the system to: generate and transmit manufacturing instructions to one or more manufacturers.
